(19) United States
(12) Patent Application Publication
(10) Pub. No.: US 2003/0225722 A1
(43) Pub. Date: Dec. 4, 2003

(54) Method and apparatus for providing multiple views of virtual documents

(75) Inventors: Gregory T. Brown, Rockmart, GA (US); Yurdaer Nezihi Doganata, Chestnut Ridge, NY (US); Youssef Drissi, Ossining, NY (US); Tong-Haing Fin, Harrison, NY (US); Moon Ju Kim, Wappingers Falls, NY (US); Lev Kozakov, Stamford, CT (US); Juan Leon-Rodriguez, Danbury, CT (US); Chien-Chiao Tu, Taipei (TW)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/157,243

(22) Filed: May 30, 2002

(51) Int. Cl. G06F 17/30

(52) U.S. Cl. 707/1

(57) ABSTRACT

A method and apparatus for providing a view of a document in a database of documents. The method includes receiving a request to crawl the documents, identifying a format for the document view, and providing the document view based on the identified format using components of the document.

### BACKGROUND OF THE INVENTION

1. Field of the Invention

The present invention generally relates to searching for information over computer networks or stand-alone systems. More specifically, the invention relates to the crawling process used by search engines to collect documents and prepare them for indexing.

2. Description of the Related Art

Search engines allow users to search various data sets available in different forms and shapes. These data sets range from relatively small sets of files stored on a desktop computer to contents distributed over a global network such as the Internet. The search engines are especially popular in the context of the World Wide Web.

The process of collecting documents, usually distributed over a large computer network or stored on a stand-alone system, is often called crawling. Crawling, indexing, and searching are fundamental features of typical search engines. Indexing is the process that enables searching the content by building a special data structure called the “inverted index”. Like indexing, crawling is typically a slow off-line process.

Preparing the content for crawling can include specific document preprocessing to be completed before the indexing phase. For example, in local (intranet) search systems that require the indexing of different document types, there might be a need for a preprocessing that converts the documents to a unified format compatible with the search engine interface.

If the same content is to be crawled by different search engines that require specific formats, the content might need to be replicated several times to have, for each search engine, a corresponding replicated content formatted according to each crawler's rules. This type of replication can also be relevant if the documents need to be presented in different contexts or with different views.

The following scenarios introduce some conventional crawling methods that illustrate the limitations and problems encountered in the current systems. In a first system 100, shown in FIG. 1, multiple search engines 102a-102c each index the same content 104. However, each search engine 102a-102c accesses the content 104 via a corresponding crawler 106a-106c each of which requires a different, specific format for input. Therefore, a preprocessing step must be performed to generate multiple, corresponding copies 108a-108c of the content 104 and to convert the replicated content 108a-108c to the format supported by each crawler's interface 106a-106c. This is a problem because there is a need of creating a specific replication of the content for each search engine. This operation not only multiplies the storage volume needed by the number of search engines, but also introduces a static process to be executed every time a search engine is added, which limits the flexibility and the automation level of the crawling process.

As shown in FIG. 2, in a second conventional crawling system 200 multiple content views 210a and 210b are created for the content 204. Multiple variants or views 210a and 210b may be required depending on the context. Such context could be defined, for example, by a user personalization preference. Moreover, the search systems and services, in this case, require the indexing of all the content views 210a-210b. One way to achieve this goal is to replicate the content for each required view. Each replication 210a-210b contains the documents in the content converted to a specific view or transformed to a specific structure compatible with a given schema. This is a problem because this requires replication of the same content multiple times to accomplish this task. Here again, the storage volume needed is multiplied by the number of views, and the process remains mostly static and difficult to adapt quickly to the addition of a new required view.

FIG. 3 shows a third conventional scenario, where the content to be searched and indexed is not organized as regular files, but rather as data records 300 stored in a relational database 304. Each record 300 or piece of information is indexed individually. At run time, a search query is submitted by the search engine 302 against the index (not shown), and a list of matching records is returned by the crawler 306 without compiling them into a “real” document. In a sense, this process disregards the relations between the different pieces of data. This is a problem because the results are not as useful as if a “real” document was retrieved which recognized the relationships between the pieces of data. The user experience, is defined by and limited to the database layout.

As shown above, some of the current crawling methods present interesting problems which are worthwhile to solve. For instance, in the case of crawling the same content by different search engine crawlers that requires different formats of the data to be crawled [See FIG. 1], there is a need of creating a specific replication of the content for each search engine. This operation not only multiplies the storage volume needed by the number of search engines, but also introduces a static process to be executed every time a search engine is added, which limits the flexibility and the automation level of the crawling process. The same problem is faced when multiple views or different context of the same content need to be indexed [See FIG. 2]. This requires replication of the same content multiple times to accomplish this task. Here again, the storage volume needed is multiplied by the number of views, and the process remains mostly static and difficult to adapt quickly to the addition of a new required view.

In the third case mentioned previously [See FIG. 3], the search engine 302 indexes unprocessed pieces 300 or records of data, and the presentation of the data, hence, the user experience, is defined by and limited to the database layout. This is another limitation to be added to the issues encountered in the other crawling modes which apply in this case as well.

### SUMMARY OF THE INVENTION

In view of the foregoing and other problems, drawbacks, and disadvantages of the conventional methods and structures, an object of the present invention is to provide a method and structure in which an improved system and method for crawling a content without creating physical files on the “hard drive” is provided.

Another object of this invention is an improved system and method that eliminates the need for replicating a content for crawling purposes.

Yet another object of this invention is an improved system and method enabling a content to be fed to multiple crawlers, even if they do not provide a common interface.

Another object of this invention is an improved document building system and method that adapts its internal data to cope with the external requirements and constraints.

In a first aspect, a method of providing a view of a document in a database of documents, includes receiving a request to crawl the documents, identifying a format for the document view: and providing the document view based on the identified format using components of the document.

In a second aspect, an apparatus for providing a view of a document, includes a database including components of a plurality of documents including the document, a document builder module in communication with the database, a configuration module in communication with the document builder module, and a format identifying module in communication with the configuration module.

In a third aspect, a method of preparing documents for subsequent searching, includes collecting documents from a document database, parsing the documents into components, and storing the components in a database.

In a fourth aspect, a signal-bearing medium tangibly embodying a program of machine-readable instructions executable by a digital processing apparatus to perform a method of providing a view of a document, includes instructions for receiving a request to crawl the documents, instructions for identifying a format for the document view, and instructions for providing the document view based on the identified format using components of the document.

In a fifth aspect, a signal-bearing medium tangibly embodying a program of machine-readable instructions executable by a digital processing apparatus to perform a method of providing a view of a document, includes instructions for collecting documents from a document database, instructions for parsing the documents into components, and instructions for storing the components in a database.

This invention relates to searching for information over computer networks and stand-alone systems. More specifically, the invention relates to a novel method of collecting, presenting, and preprocessing documents content before the indexing phase. This novel method is called “Virtual Crawling”, which is a crawling process where the documents are not stored as physical files, but as granular elements or components of the actual content. These elements are stored in a database as reusable pieces of data. A document builder module then builds a document on demand, with the desired elements. The document builder takes also as input a schema that describes in detail the element types to be collected and assembled, as well as the structure of the final document view. This module, hence, is used to render dynamically a content in different contexts based on user's preferences.

With the unique and unobvious aspects of the present invention crawling a content can be performed without creating physical files on a “hard drive”. Rather, it allows feeding a content to multiple crawlers that do not provide common interfaces. It avoids increasing storage requirements for replication purposes, and enables crawling multiple views without duplicating or replicating the original content.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 shows a block diagram of one conventional method where multiple crawlers with different proprietary interfaces crawl the same content;

FIG. 2 shows a block diagram of another conventional method where multiple views and structures of the same content are crawled by one or more crawlers;

FIG. 3 shows a block diagram of yet another conventional method where multiple data records stored in a relational database are crawled and indexed individually without consideration of the relations between the different pieces of information;

FIG. 4 shows a block diagram of one exemplary embodiment of the present invention showing a component. Extractor module, a document Builder, a configuration module, and an Interface Identification module;

FIG. 5 shows a flow chart of one exemplary embodiment of a Component Extractor module that carves documents into components that comply with a given specification schema;

FIG. 6 shows a schematic diagram of one exemplary embodiment of an Interface Identifier module, which is responsible for detecting the crawler's meta-information and sending the results to the configuration module for further processing;

FIG. 7 shows a flow chart of one exemplary embodiment of a control routine in accordance with the invention:

FIG. 8 illustrates an exemplary interface 800 for providing multiple views of virtual documents in accordance with the present invention; and

FIG. 9 illustrates a signal bearing medium 900 (e.g., storage medium) for storing steps of a program of a method according to the present invention.

### DETAILED DESCRIPTION OF EXEMPLARY EMBODIMENTS OF THE INVENTION

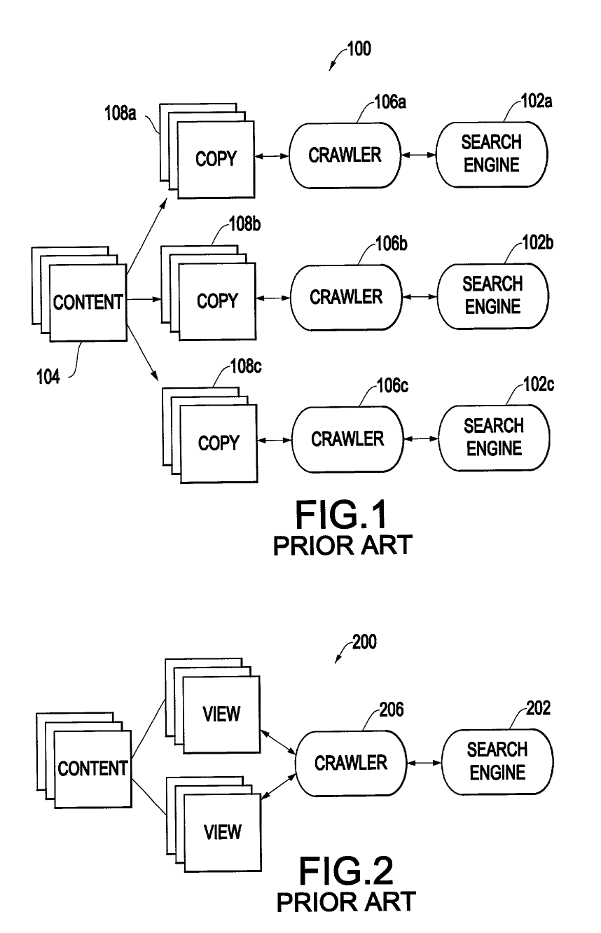

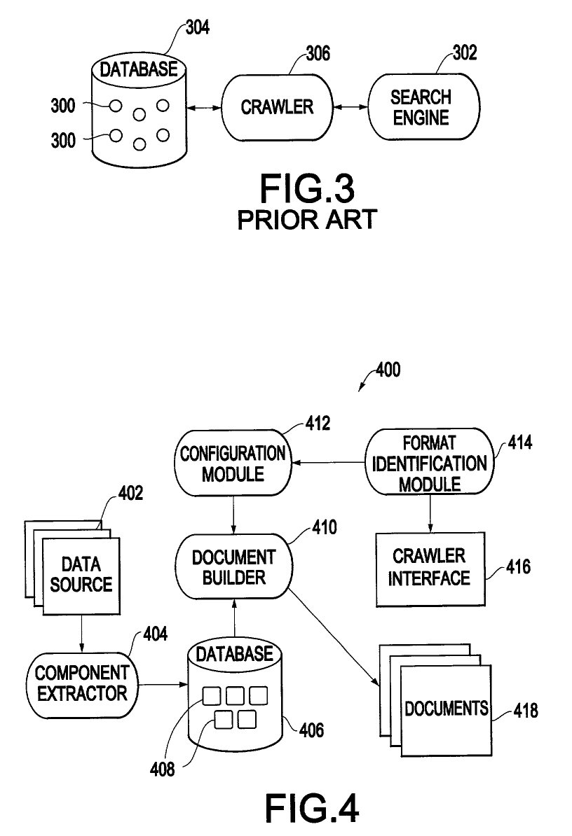

Referring now to the drawings, and more particularly to FIGS. 1-9, there are shown exemplary embodiments of the method and structures according to the present invention.

Generally, the present invention is directed to “Virtual Crawling” which is a crawling process where the documents are not stored as physical files, but as granular elements or components of the actual content. These elements are stored in a database as reusable pieces of data. A document builder module then builds a document on demand, with the desired elements. The document builder takes also as input a schema that describes in detail the element types to be collected and assembled, as well as the structure of the final document view. Thus, any document view can be created based on a user's choice or preferences. This is accomplished by a document viewer module, which is able to dynamically render the desired view of the content. This module, hence, is used to present the same content in different contexts.

The generated documents do not have to be stored physically, rather they become “virtual documents”. In a sense, there is no real physical document files in a crawling method in accordance with the present invention. Even if the search engine crawler and the indexer are perceiving their input as real document files, these documents, actually, do not exist on the “hard drive”. These documents are referred to as a “virtual document”, and their crawling process is referred to as a “virtual crawling”. These virtual documents are built on demand with the desired view in a certain context, and with no need for multiple replication of physical document files.

This inventive design eliminates the need of storing physical documents for crawling and indexing purposes. Also multiple replications are not needed for presenting different formats of the same content to different crawlers. This design further allows for more flexibility in GUI without the necessity of adding a new view of the existing content. That means that not only the maintenance cost, but also the storage cost is reduced.

Therefore, Virtual Crawling in accordance with the invention solves the problems stated above by eliminating the need for replicating documents for crawling purposes whether the same content needs to be crawled by different crawler interfaces or multiple views are required to be indexed. It also allows databases records to be compiled dynamically into documents following a given schema and structure. This is done mainly through a novel method that prepares the content to be crawled on demand and without creating physical files. This invention also adds an important flexibility and adaptability quality to the crawling process, and separates the user experience from the real data layout.

A Virtual Crawling architecture 400 of one exemplary embodiment of the invention is illustrated in FIG. 4. The architecture 400 includes component extractor module 404 which extracts the documents from the original data source 402 and carves the document into components 408 and/or sections, then stores them into a database 406. A document builder 410 is responsible for collecting context information, about the crawler's interface 416 and the corresponding document schema, from the configuration module 412.

After collecting all the necessary input, the document builder 410 creates the document streams in a memory (not shown) and feeds documents 418 to the crawler interface 416. The configuration module 412 maintains all the data about the context of the crawling process, such as the crawler interface 416, formats supported, schema, structure, and view in which the document is to be created. A format identification module 414 communicates with the crawler 416 to detect automatically the crawler's requirements regarding its interface and supported document formats, as well as the formats of seed URIs to be crawled, when applicable.

As shown in FIG. 5, the component extractor module 404 is responsible for carving the documents 402 into components 408 that comply with a given specification compiled into a schema 502 (e.g., an XML Schema). The documents 402 are accessed one by one by the extractor 504 through an access method specified by the configuration module 412. The documents 402 are then passed to the document parser 506 component which also takes as input an XML Schema 502 which specifies, in detail, how to parse the documents, as well as the formats, sizes, and other attributes of the resulting sections and components 408. The final components 408 are then stored in a database 406 with the meta-data that preserves the relations between these components themselves and also their association with the original document 402.

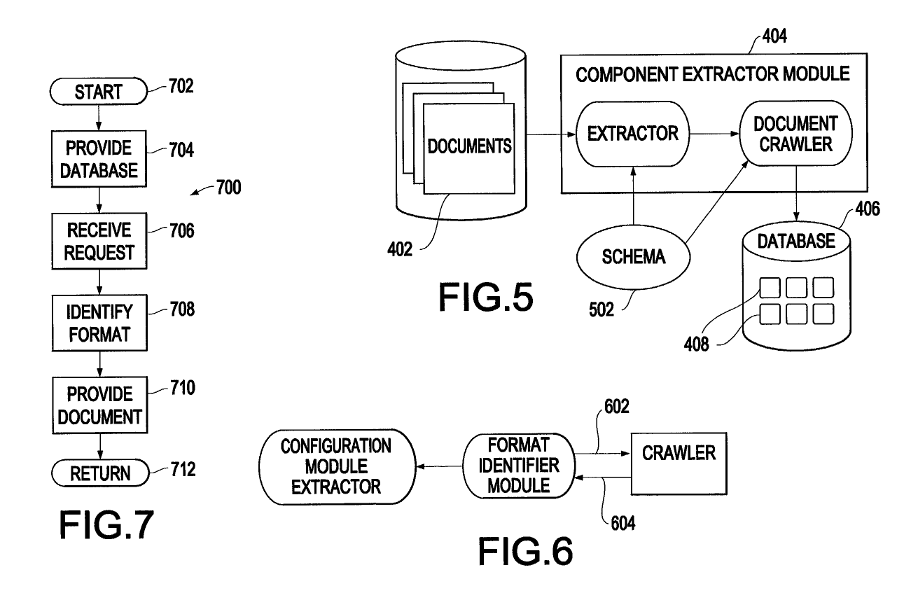

FIG. 6 shows the interface (format) identifier module 414 which is responsible for detecting the crawler's type and meta-information and sending the results to the configuration module 412 for further processing. To achieve this goal, the interface identifier module 414 establishes a protocol communication with the crawler 416 following a standard, which both the module 414 and the crawler 416 should to comply with. If not, the crawler information needs to be fed manually to the configuration module 412. Through an established connection, the module 414 sends a request 602 for the specification of the method call(s) and procedures to be followed in order to crawl a set of documents to be indexed by the search engine. The crawler 416 sends a response 604 to that request 602 by sending an XML file, which contains all necessary details describing the crawler's interface and the details of the supported formats.

The document builder module 410 is responsible for creating customized documents 418 based on context and user preferences. This information comes from the configuration module 412 which stores the data about the crawler's interface 416 and the documents schema. After collecting all the necessary input, the document builder 410, creates document streams in a memory (not shown) and feeds the documents 418 directly to the crawler 416.

Maintaining this flow avoids the creation of physical files on a “hard drive”. Once the document structure is complete and complies with the XML document schema, a document viewer (not shown) builds the final version of the document as it should be presented on the graphical user interface. This final view is dictated by the personalization and context information given by the configuration module 412.

FIG. 7 is a flowchart 700 outlining an exemplary control routine for an exemplary embodiment of the present invention. The control routine starts at step 702 and continues to step 704. In step 704, the control routine provides a database of components of documents and continues to step 707. In step 706, the control routine receives a request to search the documents from a web crawler and continues to step 708. In step 708, the control routine identifies the format for the output document requested by the web crawler and continues to step 710. In step 710, the control routine searches the components of documents in the database, assembles and provides a document based upon the requested components in the requested format. The control routine returns of the system to the control routine which called the process of FIG. 7 in step 712.

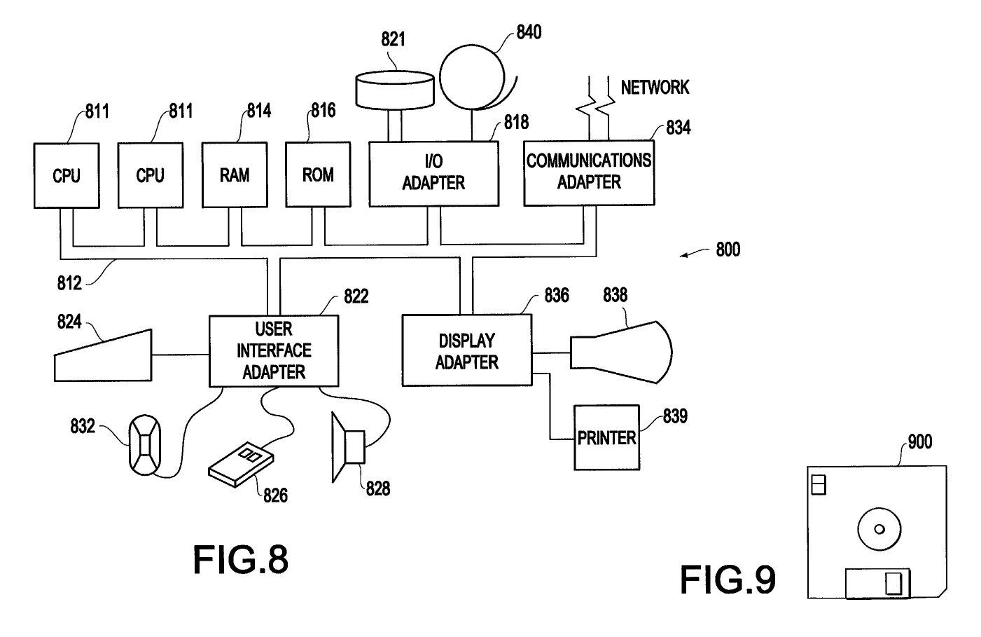

FIG. 8 illustrates an exemplary hardware configuration of an interface for providing multiple views of virtual documents in accordance with the invention and which preferably has at least one processor or central processing unit (CPU) 811.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network, etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of several exemplary embodiments, those skilled in the art will recognize that the invention can be practiced with modifications.

What is claimed is:

1. A method of providing a view of a document in a database of documents, comprising:
receiving a request to crawl said documents:
identifying a format for said document view: and
providing said document view based on said identified format using components of said document.

2. The method of claim 1, further comprising providing a database of components of said documents.

3. The method of claim 2, wherein said providing the database of components comprises parsing said documents into components.

4. The method of claim 3, wherein said providing the database of components further comprises accessing the documents through an access method specified by a predetermined schema.

5. The method of claim 3, wherein said parsing of said documents is based upon a predetermined schema.

6. The method of claim 3, further comprising storing said components into said database.

7. The method of claim 6, further comprising storing metadata which preserves the relations between said components and their association with said documents.

8. The method of claim 1, further comprising detecting a type of a crawler which is sending said request and meta-information from said crawler.

9. The method of claim 8, further comprising building said document view based upon said type of said crawler and said meta-information.

10. The method of claim 8, wherein said detecting comprises receiving an XML (extended Markup Language) file which contains details describing said crawler's interface and formats supported by said crawler.

11. The method of claim 8, wherein said detecting comprises receiving a specification of method calls and procedures to be followed.

12. An apparatus for providing a view of a document comprising:
a database including components of a plurality of documents including said document;
a document builder module in communication with said database;
a configuration module in communication with said document builder module; and
a format identifying module in communication with said configuration module.

13. The apparatus of claim 12, wherein said format identifying module is adapted to receive a request to crawl said documents in said database.

14. The apparatus of claim 13, wherein said format identifying module is responsive to said request to detect a type of a crawler and meta-information from said crawler, and to forward said type and said meta-information to said configuration module.

15. The apparatus of claim 12, wherein said configuration module is responsive to said type and said meta-information to configure said document builder module.

16. The apparatus of claim 12, further comprising a component extractor adapted to parse said documents into said components and to store said components into said database.

17. The apparatus of claim 16, wherein said component extractor comprises an extractor in communication with a document parser.

18. The apparatus of claim 17, wherein said extractor is adapted to access said documents through an access method specified by a predetermined schema and to pass said documents to said document parser.

19. The apparatus of claim 17, wherein said document parser is adapted to receive said documents from said extractor and to parse the documents into components based upon a predetermined schema.

20. The apparatus of claim 19, wherein said document parser is further adapted to store said components in said database.

21. A method of preparing documents for subsequent searching, comprising:
collecting documents from a document database;
parsing said documents into components; and
storing said components in a database.

22. The method of claim 21 further comprising:
receiving a search request; and
building a document view from said components based upon said search request.

23. The method of claim 22, wherein said building bases said document view upon a schema in said search request.

24. The method of claim 23, wherein said schema describes the types of components to be used to build said document view.

25. The method of claim 23, wherein said schema describes the structure of said document view.

26. An apparatus for providing a view of a document, comprising:
means for receiving a request to crawl said documents;
means for identifying a format for said document view; and
means for providing said document view based on said identified format using components of said document.

27. A signal-bearing medium tangibly embodying a program of machine-readable instructions executable by a digital processing apparatus to perform a method of providing a view of a document, comprising:
instructions for receiving a request to crawl said documents;
instructions for identifying a format for said document view; and
instructions for providing said document view based on said identified format using components of said document.

28. An apparatus for providing a view of a document, comprising:
means for collecting documents from a document database;
means for parsing said documents into components; and
means for storing said components in a database.

29. A signal-bearing medium tangibly embodying a program of machine-readable instructions executable by a digital processing apparatus to perform a method of providing a view of a document, comprising:
instructions for collecting documents from a document database;
instructions for parsing said documents into components; and
instructions for storing said components in a database.
